(19) United States
(12) Patent Application Publication
(10) Pub. No.: US 2004/0036922 A1
(43) Pub. Date: Feb. 26, 2004

(54) Three-dimensional image forming method and three-dimensional image forming apparatus

(75) Inventors: Kunio Yamada, Ebina-shi (JP); Makoto Hirota, Ebina-shi (JP); Takashi Yamamuro, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/365,472

(22) Filed: Feb. 13, 2003

(30) Foreign Application Priority Data
Aug. 20, 2002 (JP) 2002-239841

(51) Int. Cl. H04N 1/40; G06K 15/00

(52) U.S. Cl. 358/3.21

(57) ABSTRACT

A three-dimensional image forming method or the like is provided which is capable of forming a three-dimensional white image or black-and-white image or even a three-dimensional color image with ease and at low costs. The three-dimensional image forming method includes, for example, a first step of forming an unfoamed-toner image consisting of at least a foamable toner on paper as an image forming object by using an electrophotographic system or the like, a second step of forming a three-dimensional foamed-toner image by subjecting to heat treatment the unfoamed-toner image formed on the image forming object and foaming and fixing the foamable toner, and a third step of forming an ink image consisting of an ink on the image forming object with the foamed-toner image formed thereon by using an ink jet system.

### FIELD OF THE INVENTION AND RELATED ART STATEMENT

The present invention relates to a three-dimensional image forming method and a three-dimensional image forming apparatus, and more particularly, to a method of forming a three-dimensional image in which the three-dimensional image is formed by using a foamable toner in combination with at least an ink jet technique and a forming apparatus thereof.

The applicants of the present invention have already proposed “three-dimensional image forming method and image forming apparatus” which use a foamable toner, and the like (JP 2000-131875 A, JP 2001-194846 A, and the like).

However, these proposals disclose a method of forming a three-dimensional white image or black-and-white image, and the like, but does not particularly disclose a technique relating to an image forming method of forming a three-dimensional color image, or the like.

### OBJECT AND SUMMARY OF THE INVENTION

Therefore, the present invention mainly provides a three-dimensional image forming method and a three-dimensional image forming apparatus, which are capable of forming three-dimensional white image and black-and-white image and further a three-dimensional color image with ease and at low costs.

A three-dimensional image forming method according to the present invention is characterized by including: a first step of forming an unfoamed-toner image formed of at least a foamable toner on an image forming object by using one of an electrophotographic system and an electrostatic recording system; a second step of forming a three-dimensional foamed-toner image by subjecting to heat treatment the unfoamed-toner image formed on the image forming object and foaming and fixing the foamable toner; and third step of forming an ink image formed of an ink on the image forming object with the foamed-toner image formed thereon by using an ink jet system.

Further, a three-dimensional image forming method according to the present invention is characterized by including: a first step of forming an unfoamed-toner image formed of at least a foamable toner on an image forming object by using one of an electrophotographic system and an electrostatic recording system; a second step of forming an ink image formed of an ink on the image forming object with the unfoamed-toner image formed thereon by using an ink jet system; and a third step of forming a three-dimensional foamed-toner image by subjecting to heat treatment the unfoamed-toner image and foaming and fixing the foamable toner.

Furthermore, according to the present invention, there is provided a three-dimensional image forming method characterized by including: a first step of forming an unfoamed toner layer formed of a foamable toner in at least a partial area of an image forming object; a second step of forming an ink image formed of an ink in a partial area of the unfoamed toner layer by using an ink jet system; a third step of removing the foamable toner of the unfoamed-toner layer which exists in an area of the image forming object with no ink image formed thereon; and a fourth step of forming a three-dimensional foamed-toner image by subjecting to heat treatment an unfoamed-toner layer remaining after the third step and foaming and fixing the foamable toner.

Still further, a three-dimensional image forming method according to the present invention is characterized by including: a first step of forming an ink image formed of an ink in at least a partial area of an image forming object by using an ink jet system; a second step of forming an unfoamed-toner layer formed of a foamable toner in at least an area of the image forming object including the partial area where the ink image is formed before the ink of the ink image is dried; a third step of removing the foamable toner of the unfoamed-toner layer which exists in an area of the image forming object with no ink image formed thereon; and a fourth step of forming a three-dimensional foamed-toner image by subjecting to heat treatment an unfoamed-toner image remaining after the third step and foaming and fixing the foamable toner.

Moreover, a three-dimensional image forming apparatus according to the present invention is characterized by including: a toner-image forming apparatus for forming an unfoamed-toner image formed of at least a foamable toner on an image forming object by using one of an electrophotographic system and an electrostatic recording system; a heat treatment apparatus for forming a three-dimensional foamed-toner image by subjecting to heat treatment an unfoamed-toner image formed on the image forming object and foaming and fixing the foamable toner; and an ink-image forming apparatus for forming an ink image formed of an ink on the image forming object with the foamed-toner image formed there on by using an inkjet system.

Further, a three-dimensional image forming apparatus according to the present invention is characterized by including: a toner-image forming apparatus for forming an unfoamed-toner image formed of at least a foamable toner on an image forming object by using one of an electrophotographic system and an electrostatic recording system; an ink-image forming apparatus for forming an ink image formed of an ink on the image forming object with the unfoamed-toner image formed thereon by using an ink jet system; and a heat treatment apparatus for forming a three-dimensional foamed-toner image by subjecting to heat treatment the unfoamed-toner image and foaming and fixing the foamable toner.

Furthermore, a three-dimensional image forming apparatus according to the present invention is characterized by including: a toner-image forming apparatus or a layer forming apparatus for forming an unfoamed toner layer formed of a foamable toner in at least a partial area of an image forming object; an ink-image forming apparatus for forming an ink image formed of an ink in a partial area of the unfoamed toner layer by using an ink jet system; a removal apparatus for removing the foamable toner of the unfoamed-toner layer which exists in an area of the image forming object with no ink image formed thereon; and a heat treatment apparatus for forming a three-dimensional foamed-toner image by subjecting to heat treatment an unfoamed-toner image remaining after the third step and foaming and fixing the foamable toner.

Yet further, a three-dimensional image forming apparatus according to the present invention is characterized by including: an ink-image forming apparatus for forming an ink image formed of an ink in at least a partial area of an image forming object by using an ink jet system; a toner-image forming apparatus or a layer forming apparatus for forming an unfoamed-toner layer formed of a foamable toner in at least an area of the image forming object including the partial area where the ink image is formed before the ink of the ink image is dried; a removal apparatus for removing the foamable toner of the unfoamed-toner layer which exists in an area of the image forming object with no ink image formed thereon; and a heat treatment apparatus for forming a three-dimensional foamed-toner image by subjecting to heat treatment an unfoamed-toner image remaining after the third step and foaming and fixing the foamable toner.

According to the three-dimensional image forming method and the three-dimensional image forming apparatus of the present invention, a three-dimensional image is formed in combination with an ink jet technique, so that particularly even a three-dimensional color image can be formed with ease and at low costs.

### BRIEF DESCRIPTION OF THE DRAWINGS

Preferred embodiments of the present invention will be described in detail based upon the following drawings, wherein:

FIGS. 1A to 1C are step drawings schematically showing a main part of a three-dimensional image forming method according to Embodiment 1, in which FIG. 1A shows an image forming step using a foamable toner, FIG. 1B shows a thermal fixation step, and FIG. 1C shows an image forming step using an ink;

FIG. 2 is an illustrative diagram schematically showing a main part of a three-dimensional image forming system used for effecting the forming method of FIGS. 1A to 1C;

FIGS. 3A to 3C are step drawings schematically showing a modified embodiment of the forming method according to Embodiment 1, in which FIG. 3A shows an image forming step using a formable toner and an unfoamable toner, FIG. 3B shows a thermal fixation step, and FIG. 3C shows an image forming step using an ink;

FIGS. 4A to 4C are step drawings schematically showing another modified embodiment of the forming method according to Embodiment 1, in which FIG. 4A shows an image forming step using a formable toner and an unfoamable toner, FIG. 4B shows a thermal fixation step, and FIG. 4C shows an image forming step using an ink;

FIGS. 5A to 5C are step drawings schematically showing a main part of a three-dimensional image forming method according to Embodiment 2, in which FIG. 5A shows an image forming step using a foamable toner, FIG. 5B shows an image forming step using an ink, and FIG. 5C shows a thermal fixation step;

FIG. 6 is an illustrative diagram schematically showing a main part of a three-dimensional image forming system used for effecting the forming method of FIGS. 5A to 5C;

FIGS. 7A to 7C are step drawings schematically showing a modified embodiment of the forming method according to Embodiment 2, in which FIG. 7A shows an image forming step using a foamable toner and an unfoamable toner, FIG. 7B shows an image forming step using an ink, and FIG. 7C shows a thermal fixation step;

FIGS. 8A to 8C are step drawings schematically showing another modified embodiment of the forming method according to Embodiment 2, in which FIG. 8A shows an image forming step using a foamable toner and an unfoamable toner, FIG. 8B shows an image forming step using an ink, and FIG. 8C shows a thermal fixation step;

FIGS. 9A to 9D are step drawings schematically showing a main part of a three-dimensional image forming method according to Embodiment 3, in which FIG. 9A shows a step of forming a foamable toner layer, FIG. 9B shows an image forming step using an ink, FIG. 9C shows a step of removing a portion of the foamable toner layer, and FIG. 9D shows a thermal fixation step;

FIG. 10 is an illustrative diagram schematically showing a main part of a three-dimensional image forming system used for effecting the forming method of FIGS. 9A to 9D;

FIGS. 11A to 11D are step drawings schematically showing a main part of a three-dimensional image forming method according to Embodiment 4, in which FIG. 11A shows an image forming step using an ink, FIG. 11B shows a step of forming a foamable toner layer, FIG. 11C shows a step of removing a portion of the foamable toner layer, and FIG. 11D shows a thermal fixation step; and

FIG. 12 is an illustrative diagram schematically showing a main part of a three-dimensional image forming system used for effecting the forming method of FIGS. 11A to 11D.

### DETAILED DESCRIPTION OF THE PREFERRED EMBODIMENTS

Embodiment 1

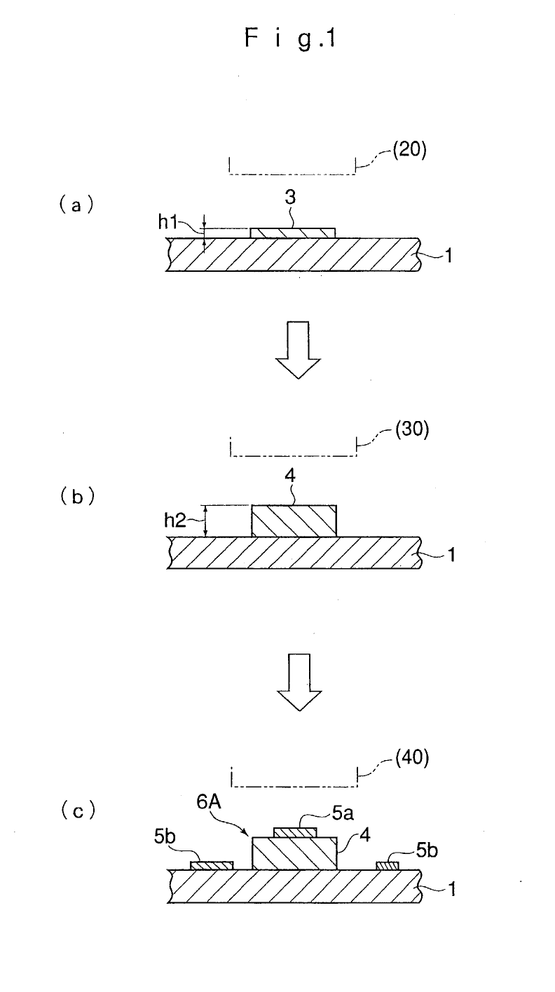

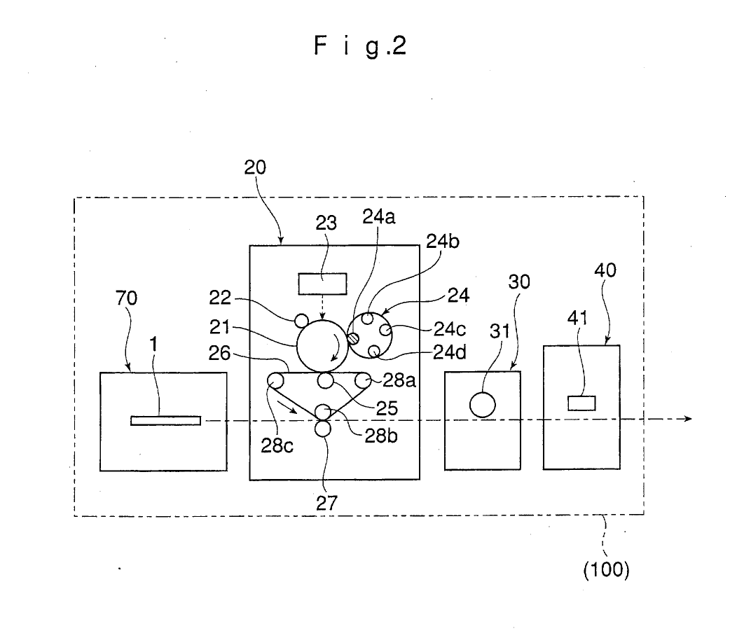

FIGS. 1A to 1C are step drawings schematically showing a main part of a three-dimensional image forming method according to Embodiment 1 of the present invention. FIG. 2 is an illustrative drawing schematically showing a main part of a three-dimensional image forming system used for effecting the forming method of FIGS. 1A to 1C.

In the method according to Embodiment 1, first, as shown in FIG. 1A, on a paper as an image forming object 1 for use of forming a three-dimensional image, an unfoamed-toner image 3 constituted by at least a foamable toner is formed into desired image contents (such as letters, symbols, diagrams, pictures, Braille, and patterns, which also applies hereinafter) by an electrophotographic toner-image forming apparatus 20 (first step: an image forming step using a foamable toner). In FIG. 1A or the like, the toner-image forming apparatus 20 is shown by illustrating a shape of its portion.

Next, as shown in FIG. 1B, the unfoamed-toner image 3 formed on the image forming object 1 in the above-mentioned first step is subjected to heat treatment by a heat treatment apparatus 30, to thereby be formed into a three-dimensional foamed-toner image 4 (second step: a thermal fixation step). Due to the heat treatment, the foamable toner in the unfoamed-toner image 3 is foamed and, at the same time, fixed to the image forming object 1. Due to the foamable toner foamed so as to expand its volume, the foamed-toner image 4 is changed into an image in which a size h2 in its thickness (height) direction is approximately three to five times as large as a size h1 of the original unfoamed-toner image 3. Also, the foamed-toner image 4, which has a structure that causes irregular reflection of light due to foaming, is externally visible as a white image. However, an image formed by using a colored foamable toner is visible as an image having a color tone similar to the color of the foamable toner. In FIG. 1B or the like, the heat treatment apparatus 30 is shown by illustrating a shape of its portion.

Subsequently, as shown in FIG. 1C, on the image-foaming object 1 with the foamed image 4 formed thereon in the second step, an ink image 5 formed of a color ink is formed by using an ink-image forming apparatus 40 of an ink jet system (third step: an image forming step using an ink). In FIG. 1C or the like, the ink-image forming apparatus 40 is shown by illustrating a shape of its portion.

Therefore, as shown in FIG. 1C, a three-dimensional color image 6A consisting of a combination of the three-dimensional foamed-toner image 4 and the color-ink image 5 is formed on the image forming object 1. Particularly, the three-dimensional color image 6A with the color-ink image 5 formed on the foamed-toner image 4 can be obtained.

The image forming object 1 used in the three-dimensional image forming method described above can have formed thereon the foamed-toner image 4 obtained by using the foamable toner and the ink image 5 while the image forming object 1 can be conveyed through the apparatuses which execute the operations in the above steps. Thus, as the image forming object 1, there can be used, in addition to the above-mentioned paper (including various types of standard-size and nonstandard-size sheets), a cardboard, an overhead projector (OHP) sheet, an envelope, a postcard, a card, or the like. Also, the image forming object 1 is supplied from, for example, a sheet feeding apparatus 70 which stores plural image forming objects 1 to be stacked on its tray and sends out the objects 1 one by one, thereby being capable of conveying and supplying the objects 1 to the toner-image forming apparatus 20 or the like.

The electrophotographic toner-image forming apparatus 20 utilizes an electrophotographic system in which at least steps of charging, exposure, and development are performed to a photosensitive member to form an image, thereby being capable of forming a toner image. Main parts of the image forming apparatus 20 adopted in Embodiment 1 are constructed by a drum-shaped photosensitive member 21 which has a photosensitive layer formed on its peripheral surface and rotates in a direction of the arrow in FIG. 2, a charging device 22 disposed on the periphery of the photosensitive member 21, an image exposure device 23, a developing device 24, a primary transfer device 25, a belt-shaped intermediate transfer member 26, a secondary transfer device 27, and the like.

In the toner-image forming apparatus 20, as the developing device 24, there is used a developing device that has a structure in which four developing units 24a to 24d each capable of storing and supplying a different color developer are allocated and attached to the peripheral surface of a rotary support, and adopts a system for moving only a developing unit corresponding to each developing step by rotating the rotary support to a developing area proximately facing the photosensitive member 21, thereby enabling use of the developing unit (so-called rotary developing device). In Embodiment 1, as the four developing units, a dual-component developing device is used which uses a dual-component developer containing a toner and a carrier. A developing unit 24a among the four developing units stores therein a dual-component developer containing a foamable toner. The other developing units 24b to 24d store therein yellow (Y), magenta (M), and cyan (C) toners, respectively. In addition, the intermediate transfer member 26 is rotatably supported by plural belt supporting rolls 28a to 28c. One of the belt supporting rolls (28b) is a drive roll for driving the intermediate transfer member 26 to be rotated in the direction of the arrow in FIG. 2.

The toner-image forming apparatus 20 is used to form the unfoamed-toner image 3 on the image forming object 1 as follows.

First, after (the photosensitive layer of) the photosensitive member 21 rotating in the direction of the arrow in FIG. 2 is uniformly charged by the charging device 22, exposure based upon image information of the unfoamed-toner image 3 (for example, scanning exposure using a laser beam) is performed to the charged photosensitive member 21 by the exposure device 23, to thereby form an electrostatic latent image thereon. Then, the electrostatic latent image is developed by the foamable toner supplied from the developing unit 24a of the developing device 24 which contains the foamable toner, to thereby become the unfoamed-toner image 3. The developing process at this time is performed based upon, for example, a magnetic-brush development, and the foamable toner adheres to the photosensitive member 21 due to the electrostatic effect. Subsequently, the unfoamed-toner image 3 formed on the photosensitive member 21 is electrostatically transferred onto the belt-shaped intermediate transfer member 26 rotating in the direction of the arrow in FIG. 2 by the primary transfer device 25. Then, the unfoamed-toner image 3 transferred onto the intermediate transfer member 26 is further electrostatically transferred onto the image forming object 1 which is sent to a secondary transfer position between the intermediate transfer member 26 and the secondary transfer device 27 at a predetermined timing. Accordingly, the unfoamed-toner image 3 is formed on a paper as the image forming object 1.

Further, the foamable toner used in Embodiment 1 is a fine particle containing at least a binder resin and a foaming agent, and is preferably a toner of such a type that the foaming agent is not substantially exposed to the surface of the toner.

There is no particular restriction on the foaming agent and any foaming agents which cause volume expansion due to heat can be used. The foaming agent may be in a solid state or a liquid state at a normal temperature. In addition, the foaming agent is not limited to a material made of a single substance but may be a material made of plural substances and a functional material such as microcapsule particles. As to the foaming temperature of the foaming agent, the preferred temperature range differs according to the apparatus used for forming a three-dimensional image. However, in the case of using an image forming apparatus such as the electrophotographic image forming apparatus, the foaming temperature is preferably equal to or lower than the heat-fixing temperature.

As the foaming agent, for example, a foaming agent made of a substance generating a gas by causing a thermal decomposition as its main constituent can be used. More specifically, examples of the foaming agent include: bicarbonate such as sodium hydrogencarbonate which generates a carbon dioxide gas by the thermal decomposition thereof; a mixture of NaNO₂ and NH₄Cl and azo compounds such as azobisisobutyronitrile, diazoaminobenzene, etc., which generates a nitrogen gas; and peroxides which generate an oxygen gas or the like, etc.

As other embodiment of the foaming agent, there is a foaming agent of microcapsule particles (hereinafter referred to as “microcapsule-type foaming agent” in some cases) containing a substance having a low-boiling temperature (which may be a solid state or a liquid state at a normal temperature) evaporating at a low temperature. The microcapsule-type foaming agent is preferred because of the high foaming property. In the case of using the foamable toner in an ordinary printer, copying machine, or the like, it is necessary that the low-boiling substance contained in the microcapsules is evaporated at a temperature lower than at least the heat-fixing temperature, and more specifically, the low-boiling substance is a substance at a temperature of 100° C. or lower, preferably 50° C., or more preferably 25° C. or lower. However, the heat respondence of the microcapsule-type foaming agent depends on not only the boiling point of the low-boiling substance, which is the core material, but also the softening point of the shell material, so that the preferred boiling point range of the low-boiling substance is not limited to the above-mentioned range. Examples of the low-boiling substance include neopentane, neohexane, isopentane, isobutylene, and isobutane. Among these substances, isobutane which is stable to the shell material of the microcapsule and has a high thermal expansion coefficient is preferred.

As the shell material of the microcapsule, a material which has a solvent resistance to various solvents used in the production process of the toner and also has an impermeability to the gas in the case of evaporating the low-boiling substance contained in the microcapsule is preferred. Also, in the case of using the image-forming toner of Embodiment 1 in an ordinary printer, copying machine, or the like, it is necessary that the shell material is softened and expands at a temperature lower than the heat-fixing temperature. As the shell material of the microcapsule, shell materials used conventionally can be widely used. For example, homopolymers such as polyvinyl chloride, polyvinyl acetate, polystyrene, polyacrylonitrile, polybutadiene, and polyacrylic acid ester, and copolymers of these are preferably used. Among these materials, a copolymer of vinylidene chloride and acrylonitrile is preferred in the points of the high adhesive property with a binder resin and the high solvent resistance to solvents.

The preferred range of the content of the foaming agent in the foamable toner differs according to the kind of the foaming agent and is usually from 5 to 50% by weight, or preferably from 10 to 40% by weight. If the content of the foaming agent is less than 5% by weight, there is a case where the thermal expansion of the toner becomes insufficient for practical use and on the other hand, if the content exceeds 50% by weight, there sometimes occurs a problem in that the content of the binder resin in the toner is relatively insufficient and sufficient fixing property is not obtained, or the like.

There is no particular restriction on the binder resin of the formable toner and resins generally used as binder resins for toners can be used. More specifically, examples of the binder resin include polyester resins, styrene resins, acrylic resins, styrene-acryl resins, silicone resins, epoxy resins, diene-based resins, phenol resins, and ethylene-vinyl acetate resins, and among these resins, the polyester resins are more preferred. Alternatively, as to this binder resin, two or more kinds of the above-mentioned polyester resins may be combined. Further, the polyester resin may be combined with another resin. In Embodiment 1, it is preferred that the polyester resin is the main constituent and another resin is added to the toner by an amount of from 0 to 30% by weight. Further, in the case of preparing the toner by dispersing a foaming agent in the monomers of the binder resin and suspension-polymerizing the mixture, the suspension-polymerizable monomer among the above monomers of the binder resins can be utilized.

By cutting the toner particle of the foamable toner and observing the cut piece by a microscope, it is confirmed that the toner particle is formed of at least a binder resin and a foaming agent particle, and is encapsulated in the core side of the toner without deteriorating the foaming property of the foaming agent particle. The foamable toner of Embodiment 1 is a toner of such a type that the foaming agent is not substantially exposed to the surface, thereby having a high thermal expansibility and also preferably maintaining satisfactorily the adhesive property to the image forming object 1 and the charging stability. Note that the term “not substantially exposed to the surface” as to the foamable toner shows that, as a result of observing an electron micrograph of, for example, 50 toner particles, the toners which are not exposed to the surface at all are 80% or more. Also, it is preferred that the foaming agents are uniformly dispersed in the toner as particles because the adhesive property of the toner to the image forming object 1 and the charging stability of the toner can be further improved.

The foamable toner having a volume average particle size of 3 to 25 μm, or preferably 7 to 15 μm is used. Although its thickness differs according to a condition such as the height of a three-dimensional image to be formed, the unfoamed toner image 3 formed of the above-mentioned foamable toner is usually formed to have a thickness of 50 μm or more at minimum, or preferably 100 μm or more.

In the heat treatment apparatus 30, the unfoamed toner image 3 formed on the paper is subjected to heat treatment by at least a heating part 31, there by being capable of forming the foamed-toner image 4. This apparatus 30, if necessary, can be structured to perform pressurizing process in addition to the heat treatment. As the heating part 31, a heat roll system, a heat belt system, or the like can be used. In the heat roll system, a heating roll is used in combination with a pressure roll or a belt to perform heating. In the heat belt system, a heating belt is used in combination with the pressure roll or the like to perform heating. In Embodiment 1, a fixing device of the heat roll system used in existing printers, copying machines, etc. (device in which a rotating heating roll is disposed in pressure contact with a pressure roll to pass a sheet between the two rolls) is adopted.

The heating temperature during the heat treatment of the unfoamed-toner image 3 is in the same range as the above-mentioned heating temperature required for the foaming agent. Also, the heating time during the heat treatment is preferably approximately 1 to 30 msec.

In the ink-image forming apparatus 40, an ink is injected as fine particles from a print head 41 which moves while scanning in a non-contacting state onto the image forming object 1 with the foamed-toner image 4 formed there on, there by being capable of forming the ink image 5 composed of desired image contents. As exemplified in FIG. 1C, the ink image 5 is approximately formed of an ink image 5a formed on the foamed-toner image 4 to be the three-dimensional image and an ink image 5b formed on a portion of the paper 1 having no foamed-toner image 4 thereon. The ink-image forming apparatus 40 of an ink jet system has a following advantage. That is, it is possible that an image can be formed in a state that the print head 41 is spaced apart from a surface of the paper as the image forming object 1 (non-contacting state), whereby even if the toner image 4 has different heights with respect to the surface of the paper, an image can be formed on any surfaces of the paper and the foamed-toner image 4.

As the ink-image forming apparatus 40, an apparatus of an ink jet system using a liquid-state ink or an apparatus of an ink jet system using a solid-state ink can be used. In the ink-image forming apparatus 40 using the liquid-state ink, there are, for example, a thermal ink jet system and a piezo system, in the viewpoint of difference in system for injecting the ink. The thermal jet type is such a type that a bubble is generated by a heating member and pressurized to thereby inject an ink from a nozzle of the head 41. The piezo system is such a type that a piezo element which is deformed when a voltage is applied thereto is used to press an ink out of the head 41. In the case of using the liquid-state ink, for the purpose of preventing the ink from permeating into the foamed-toner image 4 and lowering its color formation, the viscosity of the ink may be set to be higher than the usual value (at a level where little permeation of the ink occurs).

On the other hand, the ink-image forming apparatus 40 using a solid-state ink is an apparatus using a solid-state ink that is solid at the room temperature and becomes a liquid-state ink by being heated, and adopts the same system for injecting the liquid-state ink as that of the above-mentioned apparatus using the liquid-state ink. In particular, if an ink image 5a rich in glossiness is to be formed on the foamed-toner image 4, the ink-image forming apparatus 40 using a solid-state ink is preferably used to form the ink image. It is supposed that this is because it is difficult to permeate the solid-state ink into the foamed-toner image 4 due to the higher viscosity of the solid-state ink than that of the liquid-state ink, and therefore, when forming an image with the solid-state ink, it is likely to form an ink image which exhibits a sense of glossiness even on a rough surface of the foamed-toner image 4.

In this three-dimensional image forming method, it is easy to form an image particularly on a small and uneven surface. In addition, by adopting as the ink-image forming apparatus an ink jet system which is in expensive compared with the toner-image forming apparatus, the color ink image 5a is formed on the foamed-toner image 4. Accordingly, the three-dimensional color image 6A can be formed with ease and at low costs.

Further, as shown in FIG. 2, the structure for the formation of a three-dimensional image has the sheet feeding apparatus 70, the toner-image forming apparatus 20 for executing an operation of the image forming step using a foamable toner (first step), the heat treatment apparatus 30 for executing an operation of the thermal fixation step (second step), and the ink-image forming apparatus 40 for executing an operation of the image forming step using an ink (third step), which are arranged in this order, so that the operations of the above steps are performed integrally and continuously in the above order (In the drawing, a section 100 surrounded by the chain double dashed line represents the image forming system when being integrally structured). Moreover, a sheet conveying apparatus not shown is provided which includes a sheet conveying roll, a sheet conveying belt, a sheet conveying guide, so that a paper as the image forming object 1 sent out from the sheet feeding apparatus 70 passes through the above apparatuses 20, 30, and 40 in this order (In FIG. 2, the chain dashed line with an arrow represents a conveying path of the paper, which applies to drawings of other image forming systems). Therefore, the paper passes through each step (in other words, each apparatus) in order.

Accordingly, the three-dimensional color image described above can be formed automatically and promptly. Incidentally, if the above-mentioned sheet conveying apparatus is used, the toner-image forming apparatus 20 and the ink-image forming apparatus 40 are structured such that the images 3 and 5 are respectively formed to have no deviation with reference to one side end portion of the paper to be conveyed by the sheet conveying apparatus.

Note that, in the three-dimensional image forming method according to Embodiment 1, it is possible to adopt a structure appropriately modified as shown below.

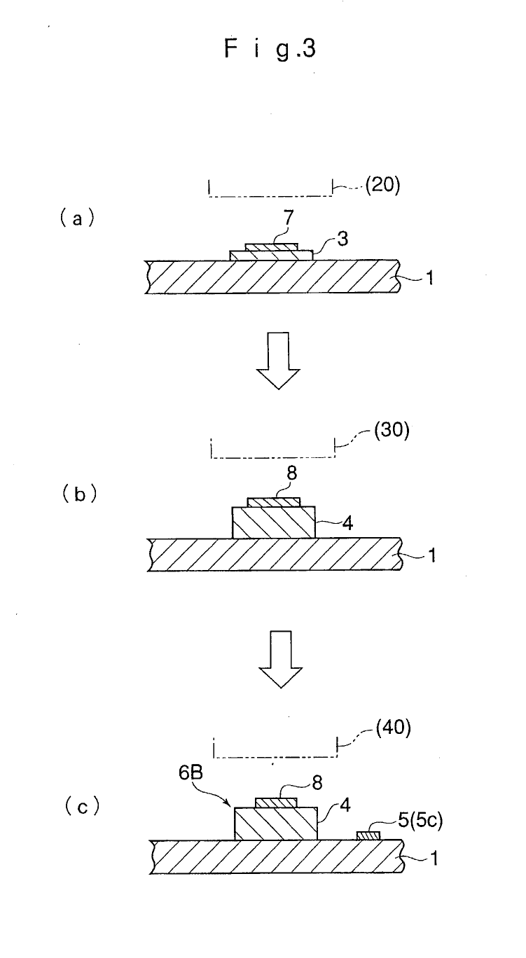

For example, as shown in FIGS. 3A to 3C, there may be adopted such a structure that, in the image forming step using a foamable toner (first step), in addition to the formation of the unfoamed-toner image 3, an unfixed-toner image 7 formed of a non-foamable toner is formed by the toner-image forming apparatus 20 separately from the unfoamed-toner image 3 (FIG. 3A), and then, in the thermal fixation step (second step), the unfixed-toner image 7 and the unfoamed-toner image 3 are simultaneously subjected to heat treatment by the heat treatment apparatus 30 (FIG. 3B).

Accordingly, as shown in FIG. 3C, there is formed on the image forming object 1 a three-dimensional color image 6 which is a combination of the three-dimensional foamed-toner image 4 and a color toner image 8.

According to the above structure, as the non-foamable toner composing the unfixed-toner image 7, there can be adopted yellow, magenta, and cyan toners, or the like used in a publicly-known printer or copying machine. Also, the non-foamable toner is stored, for example, in each of the developing units 24a to 24d of the developing device in the above toner-image forming apparatus 20, and serves to the developing step for the corresponding color. This unfixed-toner image 7 is a color-toner image. The unfixed-toner image 7 is formed on the unfoamed-toner image 3 and may be formed additionally on the paper as the image forming object 1.

The unfixed-toner image 7 is formed by the toner-image forming apparatus 20 at the same time as the unfoamed-toner image 3. That is, an electrostatic latent image corresponding to each color component of the unfixed-toner image 7 is formed on the photosensitive member 2l by the above-mentioned image forming process. Thereafter, each electrostatic latent image is developed by having each of the developing units 24a to 24d storing a toner of the corresponding color face the photosensitive member 21, to thereby obtain a toner image. Then, each toner image is transferred onto the intermediate transfer member 26 to form the unfixed-toner image 7. Concurrently with the formation of the unfixed-toner image 7, the unfoamed-toner image 3 is also formed on the photosensitive member 21 as described above. The unfoamed-toner image 3 is transferred so as to overlap with the unfixed-toner image 7 on the intermediate transfer member 26. Then, the unfixed-toner image 7 and the unfoamed-toner image 3 which are previously transferred so as to overlap with each other onto the intermediate transfer member 26 are collectively transferred onto the paper 1. As a result, the color unfixed-toner image 7 is formed so as to be overlapped on the unfoamed-toner image 3 on the paper.

After the color unfixed-toner image 7 is formed, heat treatment is performed on the color unfixed-toner image 7 as well as the unfoamed-toner image 3 by the heat treatment apparatus 30. The heating temperature during this heat treatment is preferred to be approximately 100 to 170° C. Accordingly, the non-foamable toner is heat-melted to be fixed onto the foamed-toner image 4 as the toner image 8.

As to the ink image 5 in the case of the above image forming method, either a color-ink image or a black-ink image may be used. In addition, if there is an area with no toner image 8 formed on the foamed-toner image 4, the ink image 7 may be formed in this area.

In the formation of such a three-dimensional color image 6, if the non-foamable toners used in the toner-image forming apparatus 20 are formed of only three colors, yellow, magenta, and cyan, when a black image is to be expressed by mixing the non-foamable toners of the three colors, particularly the quality of a black character image deteriorates. However, in this case, when a black-ink image 5c is formed on the image forming object 1 using a black ink in the image forming step using an ink (third step), there is an advantage in that a clear black character image or the like can be easily formed.

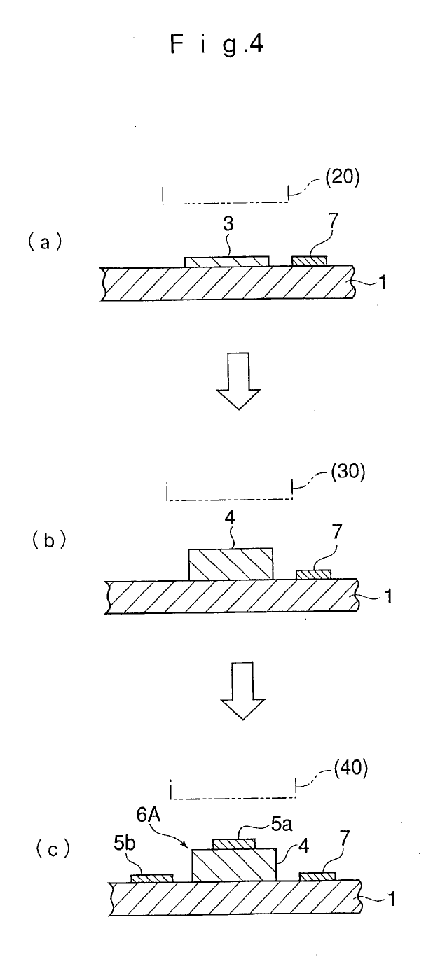

Further, in Embodiment 1, if there is used as the toner-image forming apparatus 20 a so-called single-pass two-color image forming apparatus, which has two developing devices disposed sequentially in the periphery of the photosensitive member 21 and is capable of forming two color-toner images on the photosensitive member 21 by these developing devices and then transferring the two color-toner images onto the paper simultaneously, the following structure is possible. That is, as shown in FIGS. 4A to 4C, in the image forming step using a foamable toner (first step), in addition to the formation of the unfoamed-toner image 3, the unfixed-toner image 7 formed of a non-foamable toner is formed on the image forming object 1 by the toner-image forming apparatus (FIG. 4A), and then, in the thermal fixation step (second step), the unfixed-toner image 7 and the unfoamed-toner image 3 are simultaneously subjected to heat treatment by the heat treatment apparatus 30 (FIG. 4B). In this case, by using the ink-image forming apparatus 40, the color-ink images 5a and 5b are formed on the foamed-toner image 4 or the like. Also, one of the two developing devices of the toner-image forming apparatus 20 stores the foamable toner.

In Embodiment 1, there has been shown the case where the electrophotographic system is used as the toner-image forming apparatus 20 to form the unfoamed-toner image 3. However, an electrostatic recording system in which an electrostatic latent image is formed on a dielectric to perform development may be used to form the unfoamed-toner image 3. Alternatively, as the toner-image forming apparatus 20, there can be adopted an image forming apparatus in which a toner image formed on the photosensitive member 21 is transferred directly onto the image forming object 1 without using the intermediate transfer member 26. Moreover, as the toner-image forming apparatus 20, there can be adopted a so-called tandem image forming apparatus in which single-color-image forming apparatuses each including a photosensitive member, a charging device, an image exposure device, developing device, and a primary transfer device are provided independently from each other according to the color of the toner image to be formed and are disposed sequentially in the periphery of the intermediate transfer member 26. In Embodiment 1, there has been shown the structure (image forming system 100) in which the sheet feeding apparatus 70, the toner-image forming apparatus 20 for executing an operation of the image forming step using a foamable toner (first step), the heat treatment apparatus 30 for executing an operation of the thermal fixation step (second step), and the ink-image forming apparatus 40 for executing an operation of the image forming step using an ink (third step) are arranged in this order, so that the operations of the above steps are performed integrally and continuously in this order. However, the structure maybe adapted such that at least a part of the above devices are arranged not integrally but independently from each other in an inconsecutive manner (in a state where the devices are completely separated from each other).

For example, the sheet feeding apparatus 70, the toner-image forming apparatus 20, and the heat treatment apparatus 30 may be arranged integrally while only the ink-image forming apparatus 40 is separated independently. In this case, a user manually moves the image forming object 1 with at least the foamed-toner image 4 formed thereon to the ink-image forming apparatus 40, thereby forming the ink image. Alternatively, the apparatuses 20, 30, and 40 may be separated independently from each other and the user may manually move the image forming object 1 to a next apparatus. Even in the case of these two examples, the above-mentioned three-dimensional color image can be formed in the same manner.

Embodiment 2

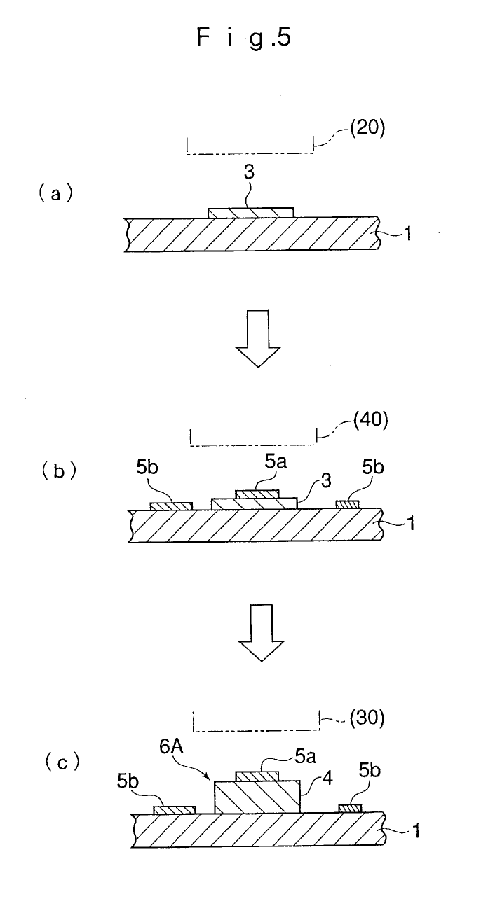

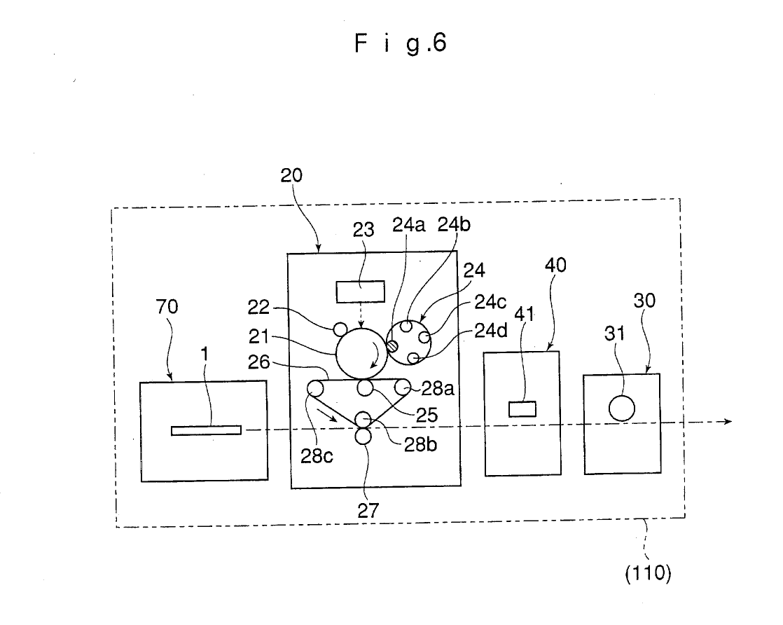

FIGS. 5A to 5C are step drawings schematically showing a main part of a three-dimensional image forming method according to Embodiment 2 of the present invention. FIG. 6 is an illustrative diagram schematically showing a main part of a three-dimensional image forming system used for effecting the forming method of FIGS. 5A to 5C.

The forming method according to Embodiment 2 is adapted to form the ink image 5 after the formation of the unfoamed-toner image 3, such that the heat treatment is finally performed on the images collectively. Otherwise, the method has the same structure as the forming method according to Embodiment 1. Also, in the image forming system for implementing the forming method, as shown in FIG. 6, the arrangement (order) of the heat treatment apparatus 30 and the ink-image forming apparatus 40 is replaced in accordance with the change in the forming method. Otherwise, the system has the same structure as the image forming system according to Embodiment 1.

In the three-dimensional image forming method according to Embodiment 2, first, as shown in FIG. 5A, on a paper as an image forming object 1 for use of forming a three-dimensional image, an unfoamed-toner image 3 constituted by at least a foamable toner is formed into desired image contents by an electrophotographic toner-image forming apparatus 20 (first step: an image forming step using a foamable toner).

Subsequently, as shown in FIG. 5B, on the image forming object 1 with the unfoamed toner image 3 formed thereon in the first step, the ink image 5 formed of a color ink is formed by using the ink-image forming apparatus 40 of the ink jet system (second step: the image forming step using an ink).

Next, the unfoamed-toner image 3 formed on the image forming object 1 in the first step is subjected to heat treatment by the heat treatment apparatus 30, to thereby be formed into the three-dimensional foamed-toner image 4 (third step: the thermal fixation step). At this time, due to the foamable toner foamed so as to expand its volume, the foamed-toner image 4 is changed into an image in which its thickness is approximately two to three times as large as that of the original unfoamed-toner image 3. Also, on the foamed-toner image 4, there exists the ink image 5a formed in the second step.

Therefore, as shown in FIG. 5C, a three-dimensional color image 6A formed of a combination of the three-dimensional foamed-toner image 4 and the color-ink image 5 is formed on the image forming object 1. Particularly, similarly to the case of Embodiment 1, the three-dimensional color image 6A with the color-ink image 5 formed on the foamed-toner image 4 can be obtained.

The three-dimensional image forming method described above can be implemented by an image forming system 110 constructed by inversely arranging (sequencing) the heat treatment apparatus 30 and the ink-image forming apparatus 40 of the image forming system 100 according to Embodiment 1.

Other structures and the like have the same structure as the modified embodiment of each structure described as the forming method and the image forming system according to Embodiment 1.

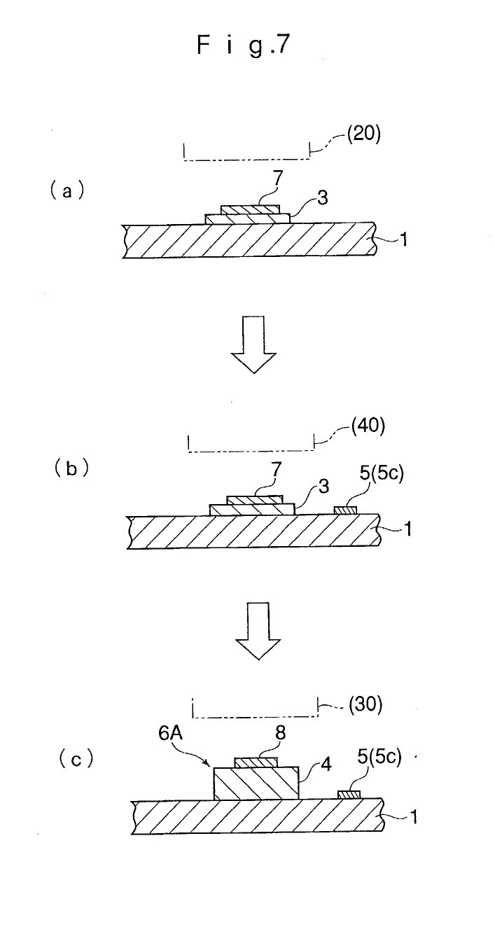

Note that FIGS. 7A to 7C show a modified embodiment of Embodiment 2, which has the same type as the modified embodiment (FIGS. 3A to 3C) of Embodiment 1. That is, the forming method according to Embodiment 2 can also be structured such that, in the image forming step using a foamable toner (first step), in addition to the formation of the unfoamed-toner image 3, an unfixed-toner image 7 formed of a non-foamable toner is formed by the toner-image forming apparatus 20 separately from the unfoamed-toner image 3 (FIG. 7A), and then, in the thermal fixation step (third step), the unfixed-toner image 7 and the unfoamed-toner image 3 are simultaneously subjected to heat treatment by the heat treatment apparatus 30 to form the toner image 8 (FIG. 7B). In this case, as shown in FIG. 7C, there can be formed a three-dimensional color image 6A in which, for example, the color-toner image 8 is formed on the foamed-toner image 4.

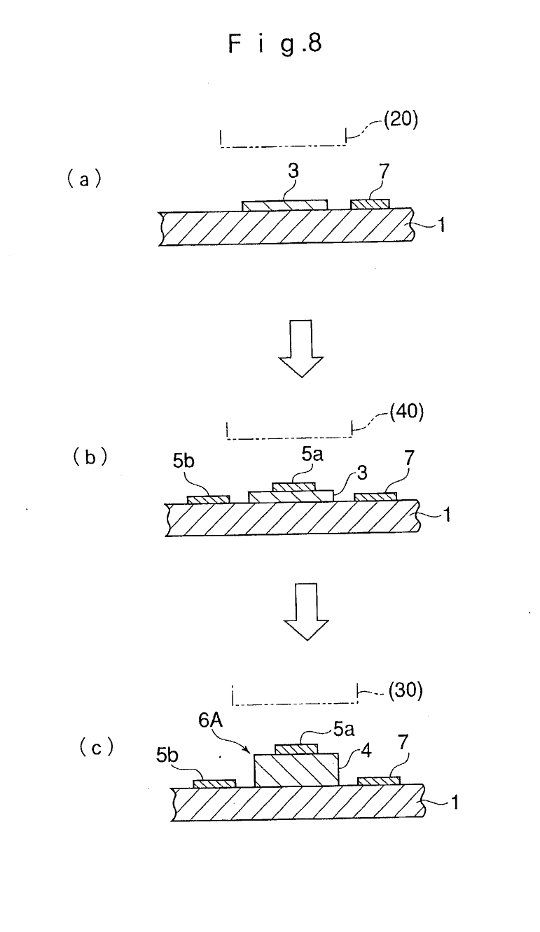

Also, FIGS. 8A to 8C show another modified embodiment of Embodiment 2, which has the same type as the modified embodiment (FIGS. 4A to 4C) of Embodiment 1. That is, the forming method according to Embodiment 2 may also be structured such that, if the so-called single-pass two-color image forming apparatus is used as the toner-image forming apparatus 20, in the image forming step using a foamable toner (first step), in addition to the formation of the unfoamed-toner image 3, the unfixed-toner image 7 formed of a non-foamable toner is formed on the image forming object 1 by the toner-image forming apparatus (FIG. 8A), and then, in the thermal fixation step (second step), the unfixed-toner image 7 and the unfoamed-toner image 3 are simultaneously subjected to heat treatment by the heat treatment apparatus 30 (FIG. 8B). In this case, as shown in FIG. 8C, there can be formed a three-dimensional color image 6A in which, for example, the color-ink image 5a is formed on the foamed-toner image 4.

Embodiment 3

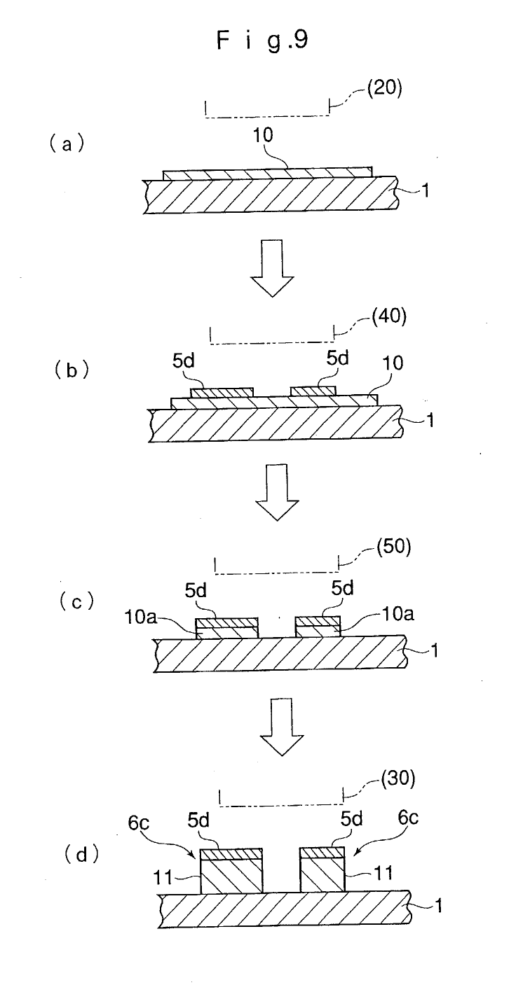

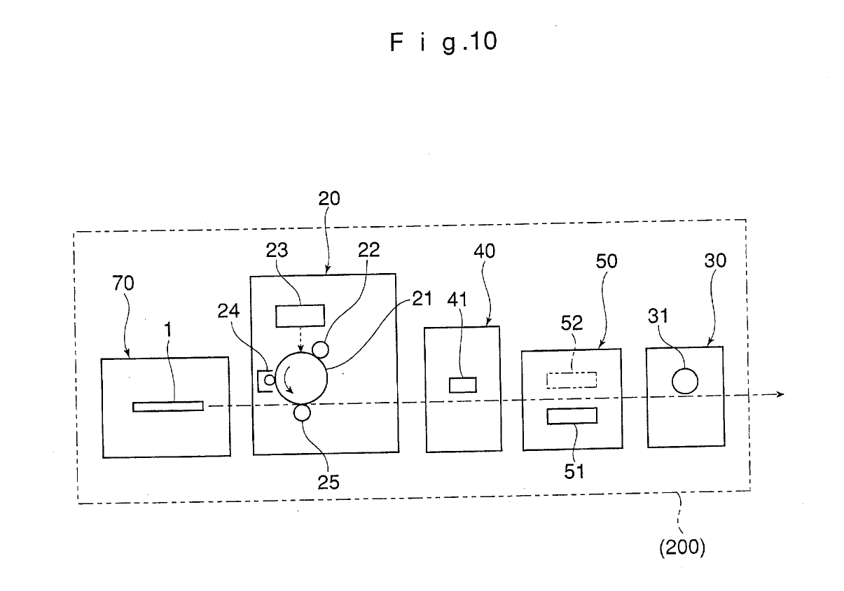

FIGS. 9A to 9D are step drawings schematically showing a main part of a three-dimensional image forming method according to Embodiment 3 of the present invention. FIG. 10 is an illustrative diagram schematically showing a main part of a three-dimensional image forming system used for implementing the forming method of FIGS. 9A to 9D.

In the method according to Embodiment 3, first, as shown in FIG. 9A, in at least a partial region of the paper as the image forming object 1, an unfoamed-toner layer 10 formed of a foamable toner is formed by the electrophotographic toner-image forming apparatus 20 (first step: a foamable-toner layer forming step). At this time, the unfoamed-toner layer 10 may be formed in a region that is larger than that of the three-dimensional image to be finally formed. Also, the unfoamed-toner layer 10 is adhered to the paper 1 mainly due to an electrostatic effect.

Next, as shown in FIG. 9B, in the partial region of the unfoamed-toner layer 10 formed on the image forming object 1 in the first step, an ink image 5d formed of an ink is formed along desired image contents by using the ink-image forming apparatus 40 of an ink jet system (second step: the image forming step using an ink). At this time, the ink image 5d is formed so as to correspond to the contents of the three-dimensional image to be formed. Also, a portion of the ink composing the ink image 5d permeates into the unfoamed-toner layer 10 to be held such that the unfoamed toner in the portion of the toner layer into which the ink image 5d permeates is adhered to the paper 1 due to the viscosity of the ink etc.

Next, as shown in FIG. 9C, (a foamable toner of) the unfoamed-toner layer 10 in the region of the paper 1 with no ink image 5d formed thereon is removed by a removal apparatus 50 (third step: a step of removing a portion of a foamed-toner layer). Thus, an unnecessary unfoamed-toner layer (foamed toner) which is irrelevant to the formation of the three-dimensional image is removed. As a result, the unfoamed-toner layer 10 basically becomes a partial layer formed in the region corresponding to the same image contents as the ink image 5d (equivalent to the above-mentioned unfoamed-toner image 3).

Next, as shown in FIG. 9D, the unfoamed-toner image 10a remaining without being removed in the third step is subjected to heat treatment by the heat treatment apparatus 30, to thereby be formed into a three-dimensional foamed-toner image 11 (fourth step: the thermal fixation step). Due to the heat treatment, the foamable toner in the unfoamed-toner layer 10 is foamed and, at the same time, fixed to the paper as the image forming object 1. Also, at this time, due to the foamable toner foamed so as to expand its volume, the foamed-toner image 11 is changed into an image in which its thickness is approximately three to five times as large as that of the original unfoamed-toner image 3.

Therefore, as shown in FIG. 9D, a three-dimensional color image 6C formed of a combination of the three-dimensional foamed-toner image 11 and the color-ink image 5d is formed on the paper as the image forming object 1. Particularly, the three-dimensional color image 6C with the color-ink image 5d formed on a foamed-ink image 11 can be obtained.

When the three-dimensional color image 6C is formed by the above forming method, it is particularly necessary that a portion of the ink forming the ink image 5d permeates into an unfoamed-ink layer 10 to reach the paper as the image forming object 1. From this viewpoint, a measure (for example, to increase the amount of the ink than the usual amount or the like) is required such that this ink excellently permeates into the unfoamed-ink layer 10 to reach the paper as the image forming object 1. Note that the unfoamed-ink layer 10 is formed to have a thickness of approximately 20 to 50 μm.

Similarly to the case of Embodiment 1, an image forming system 200 that uses the three-dimensional image forming method has the sheet feeding apparatus 70, the toner-image forming apparatus 20 for executing an operation of the forming step of a foamable toner layer (first step), the ink-image forming apparatus 40 for executing an operation of the image forming step using an ink (second step), the removal apparatus 50 for executing an operation of the step of removing a portion of a foamed-toner layer (third step), and the heat treatment apparatus 30 for executing an operation of the thermal fixation step (fourth step), which are arranged in this order, and is structured such that the operations of the above steps are performed integrally and continuously in the above order. Moreover, the above-mentioned sheet conveying apparatus is provided, so that a paper as the image forming object 1 sent out from the sheet feeding apparatus 70 passes through the above apparatuses 20, 40, 50, and 30 in this order. Therefore, the paper passes through each step (in other words, each apparatus) in order.

The toner-image forming apparatus 20, the ink-image forming apparatus 40, and the heat treatment apparatus 30 of the image forming system 200 has the same structures as those of the toner-image forming apparatus 20, the ink-image forming apparatus 40, and the heat treatment apparatus 30 of Embodiment 1. Therefore, the same symbols and the lines as Embodiment 1 are given to the common components etc. Among these, the toner-image forming apparatus 20 does not need to be provided with the plural developing units 24a to 24d (FIG. 2) as in the image forming apparatus of Embodiment 1, and may be a toner-image forming apparatus provided with one developing device 24 containing the foamable toner as shown in FIG. 10. In addition, the intermediate transferring member 26 in the image forming apparatus of Embodiment 1 is also unnecessary, and also as shown in FIG. 10, the toner-image forming apparatus 20 may be a toner-image forming apparatus having no intermediate transferring member 26 and having a system in which the toner image (image to be the unfoamed-toner layer 10) on the photosensitive member 21 is directly transferred onto the paper 1.

Also, the removal apparatus 50 for removing the unnecessary unfoamed-toner layer 10 may at least exhibit a function capable of removing the unfoamed toner of the unfoamed-toner layer 10 in the region having no ink image 5d so as not to be deposited on the ink image 5d.

In Embodiment 3, there is used the removal apparatus 50 of the system in which a mechanical vibration is imparted to the paper as the image forming object 1 that has completed the second step by a vibration imparting mechanism 51 to thereby scrape off the unnecessary unfoamed-toner layer 10. As the vibration imparting mechanism 51, specifically, there is used a structure which utilizes a high frequency vibrator or an ultrasonic oscillator. Also, FIG. 10 shows a case where the vibration imparting mechanism 51 is arranged in the opposite side (lower side of the paper in Embodiment 3) of the surface of the paper 1 where the unfoamed-toner layer 10 is formed. However, the arrangement is not limited thereto.

Other structures and the like have the same structure as the modified embodiment of each structure described as the forming method and the image forming system according to Embodiment 1.

A suction mechanism 52 may at least exhibit a function capable of suctioning and removing the unfoamed toner of the unfoamed-toner layer 10 in the region having no ink image 5d. More specifically, there is used a structure utilizing a vacuum cleaner having a small suction force. Also, the suction mechanism 52 may be provided solely by itself instead of the vibration imparting mechanism 51, or may be provided together with the vibration imparting mechanism 51. If the suction mechanism 52 is provided together with the vibration imparting mechanism 5l, it is possible to efficiently remove a portion of the foamed-toner layer 10, and, in addition, to reliably and satisfactorily remove the unnecessary unfoamed toner scraped off by the vibration imparting mechanism 51 without having the unfoamed toner deposited on the ink image 5d.

Also, in Embodiment 3, there is shown the case where the unfoamed-toner layer 10 is formed in the partial region of the paper as the image forming object 1 in the second step. However, the unfoamed-toner layer 10 may be formed in the entirety of one surface of the paper.

If the unfoamed-toner layer 10 is formed in the entirety of one surface of the paper as the image forming object 1, the image exposure device 23 of the toner-image forming apparatus 20 and the generation of image signals etc. for forming a portion of the unfoamed-toner layer 10 become unnecessary. Therefore, the toner-image forming apparatus 20 can be simplified and the costs can be reduced. Accordingly, the three-dimensional color image can be formed more inexpensively.

Also, if the unfoamed-toner layer 10 is formed in the entirety, instead of the toner-image forming apparatus 20, a layer forming unit capable of uniformly depositing the foamable toner on the paper can be used for forming the unfoamed-toner layer 10. As the layer forming unit, there can be adopted, for example, a unit for dispersing the foamable toner on the paper by using a sieve or the like, a unit for passing the paper through the container storing a foamable toner or immerse the paper into the container. Note that the unfoamed-toner layer 10 is adhered to the paper 1 mainly due to effects of an electrostatic force or a Van der Waals force.

Further, in Embodiment 3, after the three-dimensional image 6C is formed (FIG. 9D) by completing the first step to the fourth step, if necessary, on the paper as the image forming object 1 with the three-dimensional image 6C formed thereon, the ink image can be formed in the portion of the paper with no three-dimensional image 6C formed thereon again by the ink-image forming apparatus 40.

Embodiment 4

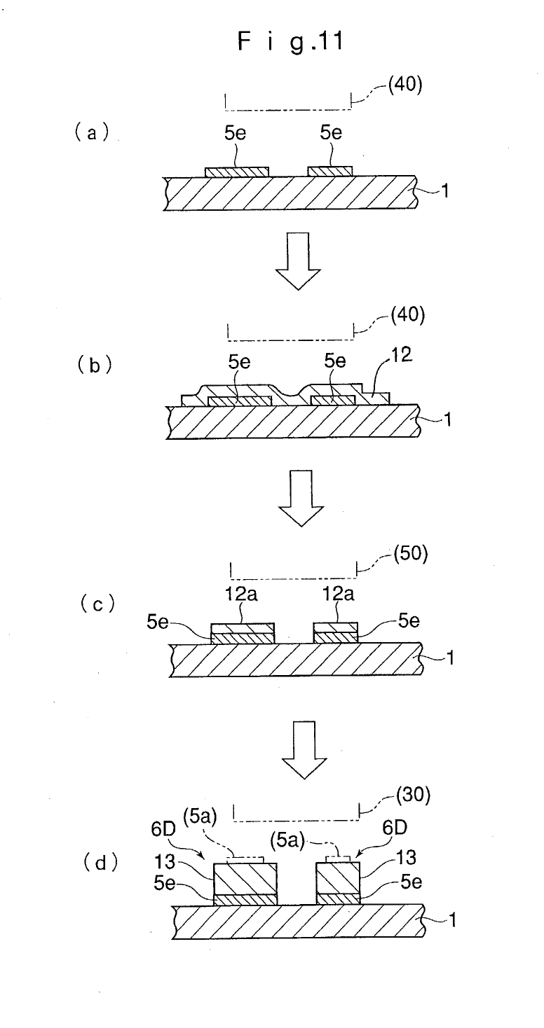

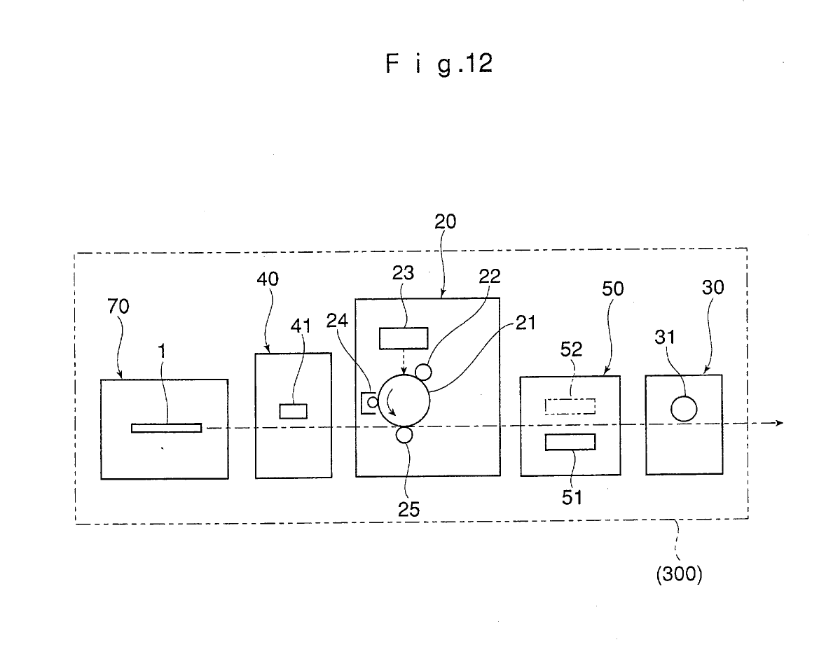

FIGS. 11A to 11D are step drawings schematically showing a main part of a three-dimensional image forming method according to Embodiment 4 of the present invention. FIG. 12 is an illustrative diagram schematically showing a main part of a three-dimensional image forming system used for implementing the forming method of FIGS. 11A to 11D.

In the method according to Embodiment 4, first, as shown in FIG. 11A, on at least a partial region of the paper as the image forming object 1, an ink image 5e formed of an ink is formed along desired image contents by using the ink-image forming apparatus 40 of an ink jet system (first step: the image forming step using an ink). At this time, the ink image 5e is formed so as to correspond to the contents of the three-dimensional image to be formed.

Next, as shown in FIG. 11B, in at least a region including the region of the paper as the image forming object 1 with the ink image 5e formed thereon, an unfoamed-toner layer 12 formed of a foamable toner is formed by the electrophotographic toner-image forming apparatus 20 before the ink of the ink image 5e is dried (second step: the foamable-toner layer forming step). At this time, the unfoamed-toner layer 12 may be formed in the region that at least covers the ink image 5e. The term “before the ink of the ink image 5e is dried” corresponds to the period during which there remains the state where the unfoamed-toner layer 12 formed on the ink image can be adhered to the ink image due to the viscosity of the ink etc.

Next, as shown in FIG. 11C, the foamable toner of the unfoamed-toner layer 12 in the region of the paper 1 with no ink image 5e formed thereon is removed by the removal apparatus 50 (third step: the step of removing a portion of a foamed-toner layer). Thus, an unnecessary unfoamed-toner layer (foamed toner) which is irrelevant to the formation of the three-dimensional image is removed. As a result, the unfoamed-toner layer 12 basically becomes a partial layer formed in the region corresponding to the same image contents as the ink image 5e (equivalent to the unfoamed-toner layer).

Next, as shown in FIG. 11D, the unfoamed-toner image 12a remaining without being removed in the third step is subjected to heat treatment by the heat treatment apparatus 30, to thereby be formed into a three-dimensional foamed-toner image 13 (fourth step: the thermal fixation step). Due to the heat treatment, the foamable toner in the unfoamed-toner layer 12 is foamed and, at the same time, fixed to the paper as the image forming object 1. Also, at this time, due to the foamable toner foamed so as to expand its volume, the foamed-toner image 13 is changed into an image in which its thickness is approximately three to five times as large as that of the original unfoamed-toner image 3.

Therefore, as shown in FIG. 11D, a three-dimensional color image 6D formed of the three-dimensional foamed-toner image 13 through the ink image 5e on the paper as the image forming object 1. Also, in this case, the three-dimensional color image 6D to be obtained is formed in the state where the foamed-toner image 13 firmly adheres to the paper 1, because the ink image 5e functions as an adhesive layer between the foamed-toner image 13 and the paper 1. Therefore, the three-dimensional color image 6D is not easily peeled from the paper 1, even if the external force is imparted to the image 6D. Thus, particularly in the case of forming the three-dimensional image such as Braille which is likely to receive the external force when being used, it becomes difficult to peel the three-dimensional image of Braille, which is therefore effective. From this viewpoint, as the ink forming the ink image 5e, the ink having adhesive property is preferably used. The ink having adhesive property is, for example, prepared by mixing an appropriate amount of a water soluble adhesive into a water soluble ink.

Also,in this case, if the ink image 5e is formed of a transparent or white ink, a three-dimensional white image can be formed.

In addition, after the fourth step is complete, on the three-dimensional color image 6D (practically, the foamed toner image 13) shown in FIG. 11D, the color ink image 5a maybe additionally formed by the ink-image forming apparatus 40 (fifth step: a color image forming step using an ink). In the case of the above structure, particularly the three-dimensional color image 6D can be obtained. Also, in this case, the formation of the color-ink image 5a may be performed by sending again the paper 1 after the fourth step is complete only to the ink-image forming apparatus 40, or by newly adding a dedicated ink-image forming apparatus for forming a color-ink image.

Similarly to the case of Embodiment 1, an image forming system 300 that uses the three-dimensional image forming method has the sheet feeding apparatus 70, the ink-image forming apparatus 40 for executing an operation of the image forming step using an ink (first step), the toner-image forming apparatus 20 for executing an operation of the forming step of a foamable toner layer (second step), the removal apparatus 50 for executing an operation of the step of removing a portion of a foamed-toner layer (third step), and the heat treatment apparatus 30 for executing an operation of the thermal fixation step (fourth step), which are arranged in this order, and is structured such that the operations of the above steps are performed integrally and continuously in the above order. Moreover, the above-mentioned sheet conveying apparatus is provided, so that a paper as the image forming object 1 sent out from the sheet feeding apparatus 70 passes through the above apparatuses 40, 20, 50, and 30 in this order. Therefore, the paper passes through each step (in other words, each apparatus) in order.

The ink-image forming apparatus 40, the toner-image forming apparatus 20, and the heat treatment apparatus 30 of the image forming system 300 has the same structures as those of the ink-image forming apparatus 40, the toner-image forming apparatus 20, and the heat treatment apparatus 30 of Embodiment 1. Therefore, the same symbols and the lines as Embodiment 1 are given to the common components etc. Among these, similarly to Embodiment 3, as the toner-image forming apparatus 20, the toner-image forming apparatus provided with one developing device 24 containing the foamable toner shown in FIG. 12 can be adopted. In addition, similarly to Embodiment 3, there can be used the toner-image forming apparatus of a system in which the toner image (image to be the unfoamed-toner layer 10) on the photosensitive member 21 is directly transferred onto the paper 1. Also, the removal apparatus 50 for removing the unnecessary unfoamed-toner layer 10 has the same structure as the removal apparatus 50 of Embodiment 3.

Other structures and the like have the same structure as the modified embodiment of each structure described in the forming method and the image forming system according to Embodiments 1 and 3.

Note that, in Embodiment 4, there is shown the case where the unfoamed-toner layer 12 is formed in the partial region (a region including at least the ink image 5e) of the paper as the image forming object 1 in the second step. However, the unfoamed-toner layer 12 may be formed in the entirety of one surface of the paper with the ink image 5e formed thereon. If the unfoamed-toner layer 12 is formed in the entirety of one surface of the paper as the image forming object 1, there can be similarly obtained various operational effects described in Embodiment 3.

What is claimed is:

1. A three-dimensional image forming method comprising:
a first step of forming an unfoamed-toner image consisting of at least a foamable toner on an image forming object by using one of an electrophotographic system and an electrostatic recording system;
a second step of forming a three-dimensional foamed-toner image by subjecting to heat treatment the unfoamed-toner image formed on the image forming object and foaming and fixing the foamable toner; and
a third step of forming an ink image consisting of ink on the image forming object with the foamed-toner image formed thereon by using an ink jet system.

2. A three-dimensional image forming method according to claim 1, wherein the ink jet system uses solid-state ink.

3. A three-dimensional image forming method according to claim 1, wherein:
in the first step, an unfixed-toner image consisting of a non-foamable toner is formed by one of the electrophotographic system and the electrostatic recording system separately from the unfoamed-toner image; and
in the second step, the unfixed-toner image and the unfoamed-toner image are subjected to heat treatment.

4. A three-dimensional image forming method according to claim 1, wherein:
an operation of the first step, an operation of the second step, and an operation of the third step are performed integrally and continuously in this order; and
the image forming object is automatically conveyed to pass through each of the steps in order.

5. A three-dimensional image forming method comprising:
a first step of forming an unfoamed-toner image consisting of at least a foamable toner on an image forming object by using one of an electrophotographic system and an electrostatic recording system;
a second step of forming an ink image consisting of an ink on the image forming object with the unfoamed-toner image formed thereon by using an ink jet system; and
a third step of forming a three-dimensional foamed-toner image by subjecting to heat treatment the unfoamed-toner image and foaming and fixing the foamable toner.

6. A three-dimensional image forming method according to claim 5, wherein the ink jet system uses solid-state ink.

7. A three-dimensional image forming method according to claim 5, wherein:
in the first step, an unfixed-toner image consisting of a non-foamable toner is formed by one of the electrophotographic system and the electrostatic recording system separately from the unfoamed-toner image; and
in the third step, the unfixed-toner image and the unfoamed-toner image are subjected to heat treatment.

8. A three-dimensional image forming method according to claim 5, wherein:
an operation of the first step, an operation of the second step, and an operation of the third step are performed integrally and continuously in this order; and
the image forming object is automatically conveyed to pass through each of the steps in order.

9. A three-dimensional image forming method comprising:
a first step of forming an unfoamed toner layer consisting of a foamable toner in at least a partial area of an image forming object;
a second step of forming an ink image consisting of ink in a partial area of the unfoamed toner layer by using an ink jet system;
a third step of removing the foamable toner of the unfoamed-toner layer which exists in an area of the image forming object with no ink image formed thereon; and
a fourth step of forming a three-dimensional foamed-toner image by subjecting to heat treatment an unfoamed-toner layer remaining after the third step and foaming and fixing the foamable toner.

10. A three-dimensional image forming method according to claim 9, wherein removal of the foamable toner in the third step is performed by one of or both of a system for shaking off a toner and a system for attracting a toner.

11. A three-dimensional image forming method according to claim 9, wherein:
an operation of the first step, an operation of the second step, an operation of the third step, and an operation of the fourth step are performed integrally and continuously in this order; and
the image forming object is automatically conveyed to pass through each of the steps in order.

12. A three-dimensional image forming method comprising:
a first step of forming an ink image consisting of an ink in at least a partial area of an image forming object by using an ink jet system;
a second step of forming an unfoamed-toner layer consisting of a foamable toner in at least an area of the image forming object including the partial area where the ink image is formed before the ink of the ink image is dried;
a third step of removing the foamable toner of the unfoamed-toner layer which exists in an area of the image forming object with no ink image formed thereon; and
a fourth step of forming a three-dimensional foamed-toner image by subjecting to heat treatment an unfoamed-toner image remaining after the third step and foaming and fixing the foamable toner.

13. A three-dimensional image forming method according to claim 12, wherein the ink of the ink image has adhesive property.

14. A three-dimensional image forming method according to claim 12, wherein removal of the foamable toner in the third step is performed by one of or both of a system for shaking off a toner and a system for attracting a toner.

15. A three-dimensional image forming method according to claim 12, wherein:
an operation of the first step, an operation of the second step, an operation of the third step, and an operation of the fourth step are performed integrally and continuously in this order; and
the image forming object is automatically conveyed to pass through each of the steps in order.

16. A three-dimensional image forming apparatus comprising:
a toner-image forming apparatus for forming an unfoamed-toner image consisting of at least a foamable toner on an image forming object by using one of an electrophotographic system and an electrostatic recording system;
a heat treatment apparatus for forming a three-dimensional foamed-toner image by subjecting to heat treatment the unfoamed-toner image formed on the image forming object and foaming and fixing the foamable toner; and
an ink-image forming apparatus for forming an ink image consisting of an ink on the image forming object with the foamed-toner image formed thereon by using an ink jet system.

17. A three-dimensional image forming apparatus comprising:
a toner-image forming apparatus for forming an unfoamed-toner image consisting of at least a foamable toner on an image forming object by using one of an electrophotographic system and an electrostatic recording system;
an ink-image forming apparatus for forming an ink image consisting of an ink on the image forming object with the unfoamed-toner image formed thereon by using an ink jet system; and
a heat treatment apparatus for forming a three-dimensional foamed-toner image by subjecting to heat treatment the unfoamed-toner image and foaming and fixing the foamable toner.

18. A three-dimensional image forming apparatus comprising:
a toner-image forming apparatus or a layer forming apparatus for forming an unfoamed toner layer consisting of a foamable toner in at least a partial area of an image forming object;
an ink-image forming apparatus for forming an ink image consisting of an ink in a partial area of the unfoamed toner layer by using an ink jet system;
a removal apparatus for removing the foamable toner of the unfoamed-toner layer which exists in an area of the image forming object with no ink image formed thereon; and
a heat treatment apparatus for forming a three-dimensional foamed-toner image by subjecting to heat treatment an unfoamed-toner layer remaining after the removal and foaming and fixing the foamable toner.

19. A three-dimensional image forming apparatus comprising:
an ink-image forming apparatus for forming an ink image consisting of an ink in at least a partial area of an image forming object by using an ink jet system;
a toner-image forming apparatus or a layer forming apparatus for forming an unfoamed-toner layer consisting of a foamable toner in at least an area of the image forming object including the partial area where the ink image is formed before the ink of the ink image is dried;
a removal apparatus for removing the foamable toner of the unfoamed-toner layer which exists in an area of the image forming object with no ink image formed thereon; and
a heat treatment apparatus for forming a three-dimensional foamed-toner image by subjecting to heat treatment an unfoamed-toner image remaining after the removal and foaming and fixing the foamable toner.
